(19) United States
(12) Patent Application Publication
(10) Pub. No.: US 2023/0099032 A1
(43) Pub. Date: Mar. 30, 2023

(54) DISTRIBUTED LEDGER LOGISTICS COMPUTER, DISTRIBUTED LEDGER LOGISTICS SYSTEM, DISTRIBUTED LEDGER LOGISTICS METHOD, AND PROGRAM

(71) Applicant: HITACHI TRANSPORT SYSTEM, LTD., Tokyo (JP)

(72) Inventor: Takashi WATANABE, Tokyo (JP)

(21) Appl. No.: 17/905,977

(22) PCT Filed: Mar. 12, 2020
(86) PCT No.: PCT/JP2020/010850

§ 371 Date: Sep. 9, 2022

(51) Int. Cl. G06Q 10/0835; G06Q 20/06; G06Q 20/10

(52) U.S. Cl. CPC G06Q 10/0835; G06Q 20/065; G06Q 20/10

(57) ABSTRACT

The present invention provides a distributed ledger logistics computer, a distributed ledger logistics system, a distributed ledger logistics method, and a program, wherein the reliability of a distributed ledger is used to issue digital currencies, and in logistics services, payments can be made each time and whether there are any unpaid or double payments is easily checked.

The present invention relates to a distributed ledger logistics computer, a distributed ledger logistics system, and a method and a program for distributed ledger logistics that utilize a distributed ledger for a logistics service. Recently, the utilization of highly reliable distributed ledgers has been pursued for logistics services.

### BACKGROUND

Such distributed ledgers are achieved by the distributed ledger technology, which is shared and managed by each node. For example, the distributed ledger is shared among nodes as a blockchain recorded as a string of data blocks.

As a utilization example of such a distributed ledger, the constitution that dispersively manages the transportation condition of a cargo and increases the reliability of data in the transportation condition is disclosed (refer to Patent Document 1).

### DOCUMENT IN THE EXISTING ART

### Patent Document

Patent Document 1: JP 2019-121198 A

Typically, the logistics service is implemented between a delivery client who requests a delivery and a delivery company who actually makes a delivery. In addition, the logistics service may be implemented by a subcontract delivery company that receives the request from the delivery company. At this point, payment for the delivery is, understandably, generated among the delivery client, the delivery company, and the subcontract delivery company.

However, the delivery company and the subcontract delivery company receive payment in a determined payment term after the delivery client requests the delivery. It is necessarily difficult for the delivery company and the subcontract delivery company to receive the payment at their desired timing. The payment was preferably made according to the timing that the delivery company and the subcontract delivery company desires.

Moreover, the composition of the Patent Document 1 is not able to dispersively manage even payment data for delivery of a bank, etc., by using a distributed ledger.

An objective of the present invention is to provide a distributed ledger logistics computer, a distributed ledger logistics system, and a method and a program for distributed ledger logistics that utilize the reliability of a distributed ledger to issue a digital currency to enable PAYG (pay-as-you-go) and easily confirm the absence or presence of a non-payment and a duplicate payment in a logistics service,

The present invention provides a distributed ledger logistics computer including:

a distributed delivery ledger writing unit that records the content of a request from a delivery client to a delivery company when the delivery company receives and accepts a delivery request from the delivery client and records delivery completion in a distributed ledger for delivery when the requested order has been delivered; and

a digital currency issuance request unit that requests a financial institution server to issue a digital currency to be paid from the delivery client to the delivery company when the delivery completion is recorded.

According to the present invention, the distributed ledger logistics computer records the content of a request from a delivery client to a delivery company when the delivery company receives and accepts a delivery request from the delivery client, records delivery completion in a distributed ledger for delivery when the requested order has been delivered, and requests a financial institution server to issue a digital currency to be paid from the delivery client to the delivery company when the delivery completion is recorded.

The present invention is the category of a distributed ledger logistics computer, but the categories of a system, a method, a program, etc. have similar functions and effects.

The present invention can provide a distributed ledger logistics computer, a distributed ledger logistics system, and a method and a program for distributed ledger logistics that utilize the reliability of a distributed ledger to issue a digital currency to enable PAYG (pay-as-you-go) and easily confirm the absence or presence of a non-payment and a duplicate payment in a logistics service.

### BRIEF DESCRIPTION OF THE DRAWINGS

FIG. 1 is a schematic diagram of the distributed ledger logistics system 1.

FIG. 2 is an overall schematic diagram of the distributed ledger logistics system 1.

FIG. 3 is a flowchart of the delivery completion writing process performed by the distributed ledger logistics computer 10, the delivery client server 100, the delivery company server 200, and the subcontract delivery company server 300.

FIG. 4 is a flowchart of the digital currency issuance process performed by the distributed ledger logistics computer 10, the delivery client server 100, the delivery company server 200, the subcontract delivery company server 300, and the financial institution server 500.

FIG. 5 is a flow chart illustrating the cash-conversion process performed by the distributed ledger logistics computer 10 and the delivery company server 200.

FIG. 6 is a flow chart illustrating the settlement process performed by the delivery client server 100.

FIG. 7 schematically shows the flow of the series of the delivery completion writing process, the digital currency issuance process, the payment process, the cash conversion process, and the settlement process that are performed by the distributed ledger logistics system 1.

FIG. 8 shows an example delivery request screen.

FIG. 9 shows an example subcontract delivery request screen.

FIG. 10 shows an example order acceptance screen for a subcontract delivery request.

FIG. 11 shows an example order list screen when a digital currency is converted into cash.

FIG. 12 shows an example shared status of the blockchain 400.

### DETAILED DESCRIPTION

Embodiments of the present invention will be described below with reference to the attached drawings. However, these are illustrative only, and the scope of the present invention is not limited thereto.

### Overview of Distributed Ledger Logistics System 1

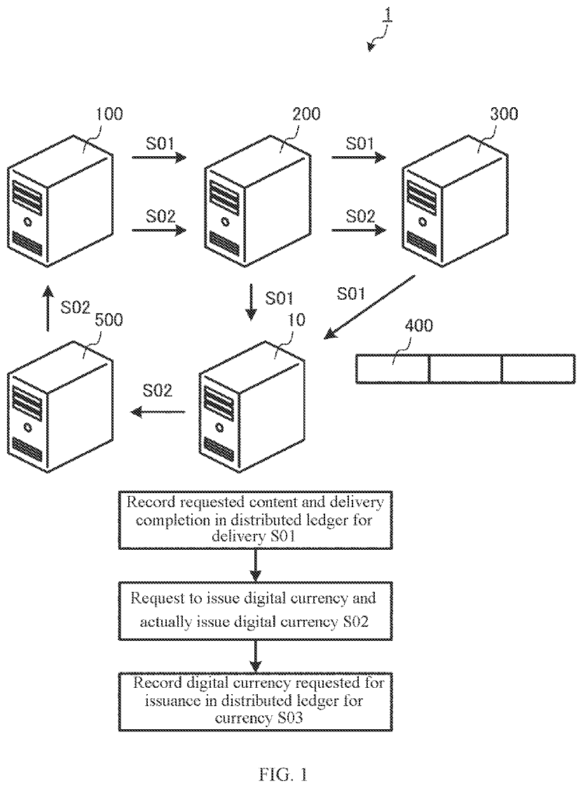

A preferable embodiment of the present invention is described below with reference to FIG. 1. FIG. 1 shows an overview of the distributed ledger logistics system 1 according to a preferable embodiment of the present invention. The distributed ledger logistics system 1 includes a distributed ledger logistics computer 10, a delivery client server 100 managed by a delivery client, a delivery company server 200 managed by a delivery company, a subcontract delivery company server 300 managed by a subcontract delivery company, and a financial institution server 500 managed by a financial institution (e.g., bank, financial institution for small business, financial institution for agriculture, forestry and fisheries, securities finance institution, non-bank, and government-affiliated financial institution, which is a computer system utilizing the distributed ledger for a logistics service.

The distributed ledger logistics system 1 may include a delivery client terminal owned by a delivery client, a delivery company terminal owned by a delivery company, a subcontract delivery company terminal owned by a subcontract delivery company, a bank terminal owned by a bank, and other terminals and devices.

The distributed ledger for delivery and the distributed ledger for currency are dispersively managed among the distributed ledger logistics computer 10, the delivery client servers 100, the delivery company server 200, and the subcontract delivery company server 300. In this embodiment, the distributed ledgers are explained as blockchains 400. Details of the blockchain 400 are described later.

The blockchain 400 only have to be dispersively managed by at least the distributed ledger logistics computer 10, the delivery client server 100, and the delivery company server 200.

The distributed ledger logistics computer 10 is data-communicatively connected with the delivery client server 100, the delivery company server 200, the subcontract delivery company server 300, and the financial institution server 500 through a public line network, etc., which transmits and receives necessary data and information and performs various processes. For example, the distributed ledger logistics computer 10 may be achieved with one computer or a plurality of computers like cloud computers. The cloud computers described herein may scalably use a computer to fulfill a specific function or contain a plurality of functional modules to achieve a certain system and freely combine the functions to use.

The delivery client server 100 is data-communicatively connected with the distributed ledger logistics computer 10, the delivery company server 200, and the financial institution server 500 through a public line network, etc., which transmits and receives necessary data and information and performs various processes. For example, the delivery client server 100 may be achieved with one computer or a plurality of computers like cloud computers.

The delivery company server 200 is data-communicatively connected with the distributed ledger logistics computer 10, the delivery client server 100, the subcontract delivery company server 300, and the financial institution server 500 through a public line network, etc., which transmits and receives necessary data and information and performs various processes. For example, the delivery company server 200 may be achieved with one computer or a plurality of computers like cloud computers.

The subcontract delivery company server 300 is data-communicatively connected with the distributed ledger logistics computer 10, the delivery company server 200, and the financial institution server 500 through a public line network, etc., which transmits and receives necessary data and information and performs various processes. For example, the subcontract delivery company server 300 may be achieved with one computer or a plurality of computers like cloud computers.

The blockchain 400 is dispersively managed by the distributed ledger logistics computer 10, the delivery client server 100, the delivery company server 200, and the subcontract delivery company server 300. The blockchain 400 is composed of blocks for each of channels in a plurality of combinations of the delivery client server 100, the delivery company server 200, and the subcontract delivery company server 300. For the blockchain 400, the first channel to which the delivery client server 100, the delivery company server 200, and the subcontract delivery company server 300 belong, the second channel to which the delivery client server 100 and the delivery company server 200 belong, and the third channel to which the delivery company server 200 and the subcontract delivery company server 300 belong exist. The distributed ledger logistics computer 10 writes necessary information acquired from the delivery client server 100, the delivery company server 200, or the subcontract delivery company server 300 in a block for an appropriate channel from among the first to third channels for the blockchain 400.

The financial institution server 500 is data-communicatively connected with the distributed ledger logistics computer 10, the delivery client server 100, the delivery company server 200, and the subcontract delivery company server 300 through a public line network, etc., which transmits and receives necessary data and information and performs various processes. For example, the financial institution server 500 may be achieved with one computer or a plurality of computers like cloud computers.

The distributed ledger logistics computer 10 records the content of a request from a delivery client to a delivery company when the delivery company receives and accepts a delivery request from the delivery client and records delivery completion in a distributed ledger for delivery when the requested order has been delivered.

For example, when the delivery company server 200 receives a delivery request from the delivery client server 100, the distributed ledger logistics computer 10 writes the delivery ID, the delivery charge, etc., that are information on the delivery request in the blockchain 400. At this time, the distributed ledger logistics computer 10 writes the information in a block for the third channel.

When the subcontract delivery company server 300 receives a delivery request from the delivery company server 200, the distributed ledger logistics computer 10 writes the delivery ID, the delivery charge, etc., that are information on the delivery request in the blockchain 400. At this time, the distributed ledger logistics computer 10 writes the information in a block for the second channel.

As the result, the distributed ledger logistics computer 10 records the content of a request from a delivery client to a delivery company when the delivery company receives and accepts a delivery request from the delivery client.

This can conceal the payment amount from a delivery company to a subcontract delivery company from the delivery client and easily lower the hurdles to attract participants.

When the distributed ledger logistics computer 10 receives a delivery completion notification from the subcontract delivery company server 300 as the transportation has been carried out and as the requested order has been delivered, the distributed ledger logistics computer 10 writes delivery completion in the blockchain 400. At this time, the distributed ledger logistics computer 10 verifies the content of the delivery completion notification against that of the delivery request and writes delivery completion when the order has been appropriately delivered. The distributed ledger logistics computer 10 writes such information in a block for the first channel.

As the result, the distributed ledger logistics computer 10 records delivery completion in a distributed ledger for delivery when the requested order has been delivered.

The content of the delivery completion notification may be verified against that of the delivery request by not only the distributed ledger logistics computer 10 but also another system or a person. The distributed ledger logistics computer 10 and any one or both of another system and a person may verify the content of the delivery completion notification against that of the delivery request. In this case, when the distributed ledger logistics computer 10 acquires the verification result, the distributed ledger logistics computer 10 writes delivery completion in the blockchain 400 as the requested order has been delivered if the order has been appropriately delivered.

Moreover, the distributed ledger logistics computer 10 may receive an input of whether or not to record delivery completion in the blockchain 400 from another system or a person and determine whether or not to record delivery completion in the blockchain 400 based on the received input.

The distributed ledger logistics computer 10 requests a financial institution server 500 to issue a digital currency to be paid from the delivery client to the delivery company when the delivery completion is recorded.

The digital currency described herein may be an original private coin (token), an original coin agreed in a preliminarily formed consortium, a currency that can be treated as the equivalent of a real currency distributed in a wide region, or an existing currency.

For example, when the distributed ledger logistics computer 10 records delivery completion, the distributed ledger logistics computer 10 outputs a request to the financial institution server 500 to issue a digital currency for the delivery client server 100. The financial institution server 500 issues a digital currency to the delivery client server 100 based on the request. For example, the digital currency is a token. The delivery client server 100 transfers the issued digital currency to the delivery company server 200.

As the result, the digital currency is issued to the delivery client.

The meaning of the issuance of a digital currency described herein includes newly generating a digital currency and not only paying the digital currency but also holding the previously generated digital currency and paying its held digital currency.

In the case where the delivery company server 200 requests a subcontract delivery company for a delivery requested from a delivery client, the delivery company pays a digital currency to the subcontract delivery company when delivery completion is recorded in a distributed ledger for delivery.

For example, the delivery company server 200 transfers a digital currency for delivery charge to the subcontract delivery company server 300 by using the issued digital currency based on the content for which the subcontract delivery company is requested.

As the result, the delivery company pays a digital currency to the subcontract delivery company.

The distributed ledger logistics computer 10 records a request to ask the financial institution server 500 to issue a digital currency in a distributed ledger for currency.

For example, the distributed ledger logistics computer 10 writes the digital currency, the issuance of which the financial institution server 500 was requested in the blockchain 400, as the payment result of the digital currency. At this time, the distributed ledger logistics computer 10 writes such information in a block for the first channel.

The distributed ledger logistics computer 10 also writes the digital currency issued by the delivery client server 100 for the delivery company server 200 in the blockchain 400 as the payment result of the digital currency. At this time, the distributed ledger logistics computer 10 writes the payment result in a block for the third channel.

The distributed ledger logistics computer 10 also writes the digital currency paid to the subcontract delivery company server 300 in the blockchain 400 as the payment result of the digital currency. At this time, the distributed ledger logistics computer 10 writes the payment result in a block for the second channel.

As the result, the distributed ledger logistics computer 10 records a request for issuance of a digital currency and the actual issuance in a distributed ledger for currency. The issuance of a digital currency is written in a distributed ledger for currency as a payment result to enable a secured credit and PAYG and easily confirm the absence or presence of a non-payment and a duplicate payment in a logistics service.

The overview of the process performed by the distributed ledger logistics system 1 is described below.

The distributed ledger logistics computer 10 records the content of a request from a delivery client to a delivery company when the delivery company receives and accepts a delivery request from the delivery client and records delivery completion in a distributed ledger for delivery when the requested order has been delivered (Step S01).

For example, when the delivery company server 200 receives a delivery request from the delivery client server 100, the distributed ledger logistics computer 10 writes the delivery ID, the delivery charge, etc., in a block for the third channel in the blockchain 400.

When the distributed ledger logistics computer 10 receives a delivery completion notification from the delivery company server 200 as the transportation has been carried out and as the requested order has been delivered, the distributed ledger logistics computer 10 writes delivery completion in a block for the first channel in the blockchain 400.

In the case where the delivery company requests the subcontract delivery company server 300 for the delivery request, the distributed ledger logistics computer 10 writes the delivery ID, the delivery charge, etc., in a block for the second channel in the blockchain 400 when the subcontract delivery company server 300 accepts a delivery request from the delivery company server 200.

When the distributed ledger logistics computer 10 receives a delivery completion notification from the subcontract delivery company server 300, the distributed ledger logistics computer 10 writes delivery completion in a block for the first channel in the blockchain 400.

The distributed ledger logistics computer 10 requests a financial institution server 500 to issue a digital currency to be paid from the delivery client to the delivery company when the delivery completion is recorded (Step S02).

When the distributed ledger logistics computer 10 records delivery completion, the distributed ledger logistics computer 10 outputs a request to the financial institution server 500 to issue a digital currency for the delivery client server 100. The financial institution server 500 issues a digital currency to the delivery client server 100 based on the request. The delivery client server 100 transfers the issued digital currency to the delivery company server 200.

In the case where a delivery company requests a subcontract delivery company for a delivery from a delivery client, the delivery company pays the delivery charge to the subcontract delivery company by using the issued digital currency.

The delivery company server 200 transfers a digital currency for delivery charge to the subcontract delivery company server 300 by using the issued digital currency based on the content for which the subcontract delivery company is requested.

The distributed ledger logistics computer 10 records a request to ask the financial institution server 500 to issue a digital currency in a distributed ledger for currency (Step S03).

The distributed ledger logistics computer 10 writes the digital currency, the issuance of which the financial institution server 500 was requested in the blockchain 400, as the payment result of digital currency. At this time, the distributed ledger logistics computer 10 writes such information in a block for the first channel.

The distributed ledger logistics computer 10 also writes the digital currency issued for the delivery company server 200 in a block for the second channel in the blockchain 400 as the payment result of the digital currency.

In the case where a delivery is requested from a delivery client to a subcontract delivery company, the distributed ledger logistics computer 10 also writes the digital currency paid from the delivery company server 200 to the subcontract delivery company server 300 in a block for the third channel in the blockchain 400 as the payment result of the digital currency.

### System Configuration of Distributed Ledger Logistics System 1

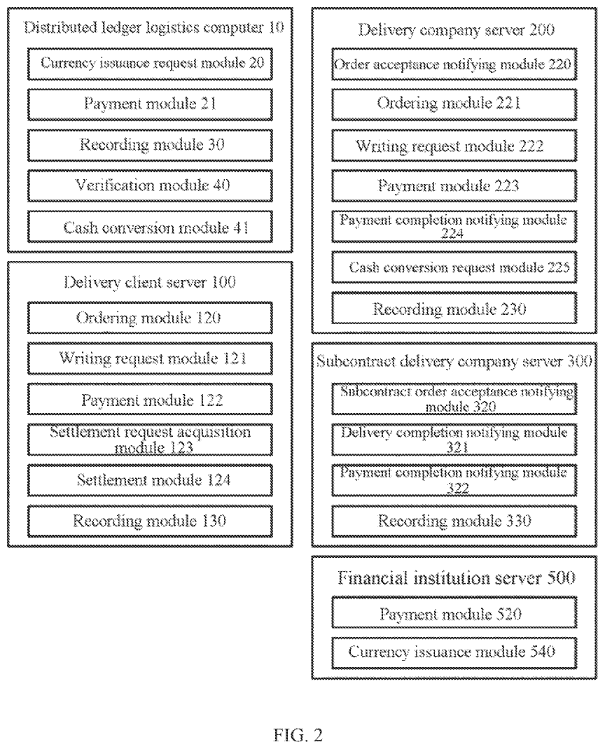

The system configuration of the distributed ledger logistics system 1 according to a preferable embodiment is described below with reference to FIG. 2. FIG. 2 is a block diagram illustrating the distributed ledger logistics system 1 according to a preferable embodiment of the present invention. In FIG. 2, the distributed ledger logistics system 1 includes a distributed ledger logistics computer 10, a delivery client server 100, a delivery company server 200, a subcontract delivery company server 300, and a financial institution server 500, which is a computer system utilizing the distributed ledger for a logistics service.

The distributed ledger logistics system 1 may include a delivery client terminal, a delivery company terminal, a subcontract delivery company terminal, a bank terminal that are described above, and other terminals and devices.

The distributed ledger logistics computer 10 is data-communicatively connected with the delivery client server 100, the delivery company server 200, and the subcontract delivery company server 300 through a public line network, etc., which transmits and receives necessary data and information and performs various processes as described above. For example, the distributed ledger logistics computer 10 may be achieved with one computer or a plurality of computers like cloud computers.

The distributed ledger logistics computer 10 includes a control unit provided with a central processing unit (CPU), a graphics processing unit (GPU), a random access memory (RAM), and a read only memory (ROM); and a communication unit such as a device that is capable to communicate with other terminals and devices, for example, a Wireless Fidelity or Wi-Fi® enabled device complying with IEEE 802.11. The distributed ledger logistics computer 10 also includes a memory unit such as a hard disk, a semiconductor memory, a record medium, or a memory card to store data. The distributed ledger logistics computer 10 also includes a processing unit provided with various devices that perform various processes.

In the distributed ledger logistics computer 10, the control unit reads a predetermined program to achieve a currency issuance request module 20 and a payment module 21 in cooperation with the communication unit. Furthermore, in the distributed ledger logistics compute 10, the control unit reads a predetermined program to achieve a recording module 30 in cooperation with the memory unit. Furthermore, in the distributed ledger logistics compute 10, the control unit reads a predetermined program to achieve a verification module 40 and a cash conversion module 41 in cooperation with the processing unit.

The delivery client server 100 is data-communicatively connected with the distributed ledger logistics computer 10 and the delivery company server 200 through a public line network, etc., which transmits and receives necessary data and information and performs various processes, as described above. For example, the delivery client server 100 may be achieved with one computer or a plurality of computers like cloud computers.

The delivery client server 100 includes a control unit including a CPU, a GPU, a RAM, and a ROM, a communication unit such as a device that is capable to communicate with other terminals and devices, a memory unit to store data, and a processing unit provided with various devices that perform various processes in the same way as the distributed ledger logistics computer 10.

In the delivery client server 100, the control unit reads a predetermined program to achieve an ordering module 120, a writing request module 121, a payment module 122, a settlement request acquisition module 123, and a settlement module 124 in cooperation with the communication unit. Furthermore, in the delivery client server 100, the control unit reads a predetermined program to achieve a recording module 130 in cooperation with the memory unit.

The delivery company server 200 is data-communicatively connected with the distributed ledger logistics computer 10, the delivery client server 100, and the subcontract delivery company server 300 through a public line network, etc., which transmits and receives necessary data and information and performs various processes, as described above. For example, the delivery company server 200 may be achieved with one computer or a plurality of computers like cloud computers.

The delivery company server 200 includes a control unit including a CPU, a GPU, a RAM, and a ROM, a communication unit such as a device that is capable to communicate with other terminals and devices, a memory unit to store data, and a processing unit provided with various devices that perform various processes in the same way as the distributed ledger logistics computer 10.

In the delivery company server 200, the control unit reads a predetermined program to achieve an order acceptance notifying module 220, an ordering module 221, a writing request module 222, a payment module 223, a payment completion notifying module 224, and a cash conversion request module 225 in cooperation with the communication unit. Furthermore, in the delivery company server 200, the control unit reads a predetermined program to achieve a recording module 230 in cooperation with the memory unit.

The subcontract delivery company server 300 is data-communicatively connected with the distributed ledger logistics computer 10 and the delivery company server 200 through a public line network, etc., which transmits and receives necessary data and information and performs various processes, as described above. For example, the subcontract delivery company server 300 may be achieved with one computer or a plurality of computers like cloud computers.

The subcontract delivery company server 300 includes a control unit including a CPU, a GPU, a RAM, and a ROM, a communication unit such as a device that is capable to communicate with other terminals and devices, a memory unit to store data, and a processing unit provided with various devices that perform various processes in the same way as the distributed ledger logistics computer 10.

In the subcontract delivery company server 300, the control unit reads a predetermined program to achieve a subcontract order acceptance notifying module 320, a delivery completion notifying module 321, and a payment completion notifying module 322 in cooperation with the communication unit. Furthermore, in the subcontract delivery company server 300, the control unit reads a predetermined program to achieve a recording module 330 in cooperation with the memory unit.

The blockchain 400 is dispersively managed by the distributed ledger logistics computer 10, the delivery client server 100, the delivery company server 200, and the subcontract delivery company server 300, as described above. The blockchain 400 is a string of blocks for each channel as described above. The blockchain 400 is dispersively managed by the recording module 30, the recording module 130, the recording module 230, and the recording module 330.

The blockchain 400 only have to be dispersively managed by at least the distributed ledger logistics computer 10, the delivery client server 100, and the delivery company server 200.

The financial institution server 500 is data-communicatively connected with the distributed ledger logistics computer 10 and the delivery client server 100 through a public line network, etc., which transmits and receives necessary data and information and performs various processes, as described above. For example, the financial institution server 500 may be achieved with one computer or a plurality of computers like cloud computers.

The financial institution server 500 includes a control unit including a CPU, a GPU, a RAM, and a ROM, a communication unit such as a device that is capable to communicate with other terminals and devices, a memory unit to store data, and a processing unit provided with various devices that perform various processes in the same way as the distributed ledger logistics computer 10.

In the financial institution server 500, the control unit 11 reads a predetermined program to achieve a payment module 520 in cooperation with the communication unit. Furthermore, in the financial institution server 500, the control unit reads a predetermined program to achieve a currency issuance module 540 in cooperation with the processing unit.

### Delivery Completion Writing Process

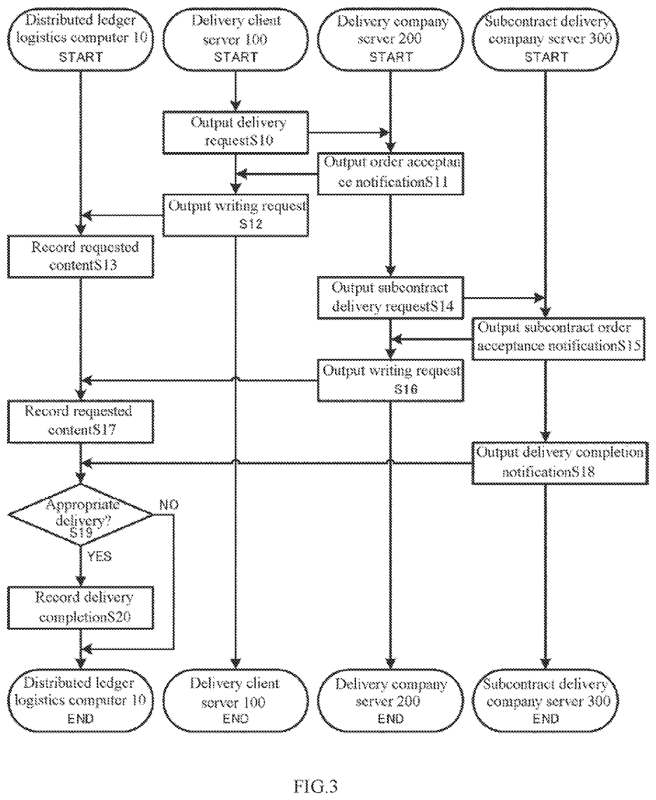

The delivery completion writing process performed by the distributed ledger logistics system 1 is described below with reference to FIG. 3. FIG. 3 is a flowchart of the deliver completion writing process performed by the distributed ledger logistics computer 10, the delivery client server 100, the delivery company server 200, and the subcontract delivery company server 300. The tasks executed by the modules of each of the above-mentioned devices will be explained below together with this process.

The ordering module 120 outputs a delivery request to the delivery company server 200 to order the delivery of an item (Step S10). In Step S10, the ordering module 120 outputs a delivery request including the delivery ID, the delivery charge, the name of the item, the type, the delivery origin, the delivery place, and the delivery date. The delivery company server 200 accepts an order by receiving the delivery request and receiving an input from a delivery company staff, etc. The delivery company delivers the item or requests the subcontract delivery company to deliver the item based on the delivery request.

The order acceptance notifying module 220 outputs an order acceptance notification that the delivery request has been accepted to the delivery client server 100 (Step S11). In Step S11, the order acceptance notifying module 220 outputs the order acceptance notification to the delivery client server 100. The delivery client server 100 receives the order acceptance notification.

The writing request module 121 outputs a writing request to the distributed ledger logistics computer 10 to record the content requested from the delivery client to the delivery company in the blockchain 400 (Step S12). In Step S12, the writing request module 121 transmits a writing request to the distributed ledger logistics computer 10 to record the content of the request in the blockchain 400 as the requested content. The distributed ledger logistics computer 10 receives the writing request.

The recording module 30 records the requested content including the delivery ID, the delivery charge, the name of the item, the type, the delivery origin, the delivery place, and the delivery date in the blockchain 400 based on the writing request (Step S13). In Step S13, the recording module 30 records the requested content in a block for the third channel in the blockchain 400. At this time, the delivery charge is the number of tokens paid by using a digital currency.

The distributed ledger logistics computer 10, the delivery client server 100, the delivery company server 200, and the subcontract delivery company server 300 share and dispersively manage the blockchain 400 in which the requested content is newly recorded.

The ordering module 221 outputs a subcontract delivery request to subcontract delivery company server 300 to order the delivery of an item to a subcontract delivery company (Step S14). In Step S14, the ordering module 221 outputs the subcontract delivery request including the delivery ID, the delivery charge, the name of the item, the type, the delivery origin, the delivery place, and the delivery date. The subcontract delivery company server 300 accepts an order by receiving the subcontract delivery request and receiving an input from a subcontract delivery company staff, etc. The subcontract delivery company delivers the item or requests the subcontract delivery company to deliver the item based on the subcontract delivery request.

The subcontract order acceptance notifying module 320 outputs a subcontract order acceptance notification that the subcontract order acceptance notifying module 320 has accepted the subcontract delivery request to the delivery company server 200 (Step S15). In Step S15, the subcontract order acceptance notifying module 320 outputs the subcontract order acceptance notification to the delivery company server 200. The delivery company server 200 receives the subcontract order acceptance notification.

The writing request module 222 outputs a writing request to the distributed ledger logistics computer 10 to record the content requested from the delivery company to the subcontract delivery company in the blockchain 400 (Step S16). In Step S16, the writing request module 222 transmits a writing request to the distributed ledger logistics computer 10 to record the content of the subcontract delivery request in the blockchain 400 as the requested content. The distributed ledger logistics computer 10 receives the writing request.

The recording module 30 records the content of the subcontract delivery request including the delivery ID, the delivery charge, the name of the item, the type, the delivery origin, and the delivery place, the delivery date in the blockchain 400 based on the writing request (Step S17). In Step S17, the recording module 30 records the requested content in a block for the second channel in the blockchain 400. At this time, the delivery charge is the number of tokens paid by using a digital currency.

The distributed ledger logistics computer 10, the delivery client server 100, the delivery company server 200, and the subcontract delivery company server 300 share and dispersively manage the blockchain 400 in which the requested content is newly recorded.

The subcontract delivery company server 300 outputs vehicle information on the vehicle making the delivery (e.g., order ID, orderer ID, vehicle ID, driver ID, the number of vehicles) to the delivery company server 200.

The delivery company server 200 acquires the vehicle information and outputs the acquired vehicle information to the delivery client server 100. If the delivery company does not request the subcontract delivery company for the delivery requested by the delivery client, the distributed ledger logistics system 1 omits the process of the above-mentioned Steps S14 to S17 and performs the processes described later. In this case, the delivery company server 200 performs the processes performed by the subcontract delivery company server 300 in the processes described later.

As the result of the process, the distributed ledger logistics computer 10 records the content of a request from a delivery client to a delivery company when the delivery company accepts a delivery request from the delivery client.

This can conceal the payment amount from a delivery company to a subcontract delivery company from the delivery client and easily lower the hurdles to attract participants.

The delivery completion notifying module 321 outputs a delivery completion notification that the transportation has been carried out and that the requested order has been delivered to the distributed ledger logistics computer 10 (Step S18). In Step S18, the delivery completion notifying module 321 transmits the delivery completion notification including the delivery ID, the number of the item, the delivery origin, the delivery place, and the delivery date to the distributed ledger logistics computer 10. The distributed ledger logistics computer 10 receives the delivery completion notification.

An example delivery completion notification is described below. The driver who has carried out the transportation reads the two-dimensional code shown in the receipt with a subcontract delivery company terminal and starts an application. The driver takes an image of the two-dimensional code and the receipt stamp shown in the receipt with the application. The driver outputs the image of the two-dimensional code and the receipt stamp and the delivery ID printed in the two-dimensional code as a delivery completion notification from the subcontract delivery company terminal to the distributed ledger logistics computer 10 directly or through the subcontract delivery company server 300. On taking the image, the position information and the time information may be acquired and added to and stored in the image. The position information and the time information can make it possible to learn the more exact evidence of delivery and advantage the verification against the requested content. For example, the position information can be acquired as a latitude and a longitude from GPS (Global Positioning System) or the device ID of a base station emitting electric waves, for example, in a neighboring wireless LAN (Local Area Network).

The verification module 40 verifies the acquired delivery completion notification against the delivery request from the delivery client and judges whether or not the delivery has been appropriately made (Step S19). In Step S19, the verification module 40 checks whether or not the delivery ID in the acquired delivery completion notification corresponds to that in the delivery request written in the blockchain 400. If the verification module 40 judges that the delivery IDs do not correspond to each other (Step S19 NO), the verification module 40 judges that the delivery has not been appropriately made, and the distributed ledger logistics computer 10 ends the process. The information and the process used for the verification that are described above are just an example. The information and process used for the verification are not limited to the example. For example, the process to compare the appointed delivery time with the actual delivered time, the process to compare the position information added to the image and the position information of the vehicle, and other processes may be appropriately combined and added. The verification accuracy can be improved by increasing the type of information and the process of verification.

If the verification module 40 judges that the delivery has not been appropriately made, the distributed ledger logistics computer 10 outputs a notification that the delivery has not been appropriately made to any one or any combination of the delivery client server 100, the delivery company server 200, and the subcontract delivery company server 300.

In Step S19, if the verification module 40 judges that the delivery IDs correspond to each other (Step S19 YES), the verification module 40 judged that the delivery has been appropriately made, and the recording module 30 records delivery completion in the blockchain 400 (Step S20). In Step S20, the recording module 30 records the completion of the delivery identified by the delivery ID in a block for the first channel in the blockchain 400.

The distributed ledger logistics computer 10, the delivery client server 100, the delivery company server 200, and the subcontract delivery company server 300 share and dispersively manage the blockchain 400 in which the delivery completion is newly recorded.

As the result, the distributed ledger logistics computer 10 records delivery completion in a distributed ledger for delivery when the requested order is delivered.

The process of the above-mentioned Step S19 performed by the verification module 40 may be based on an input from another system or a person. Specifically, the distributed ledger logistics computer 10 may receive an input of the verification of the content of the delivery completion notification against that of the delivery request (the order has been appropriately delivered or not) from another system or a person and judge whether or not the delivery has been appropriately made based on the received input.

Moreover, the distributed ledger logistics computer 10 may receive an input of whether or not to record delivery completion in the blockchain 400 from another system or a person and determine whether or not to record delivery completion in the blockchain 400 based on the received input.

The verification modules 40 may judge whether or not the deliver has been appropriately made by a method other than that of verifying the delivery IDs against each other, for example, a method of verifying the validity of the delivery slip or the signature.

In the distributed ledger logistics system 1, after the delivery completion is recorded in the blockchain 400, the delivery company server 200 outputs the invoice for the delivery to the delivery client server 100, and the subcontract delivery company server 300 outputs the invoice for the delivery to the delivery company server 200. The delivery client server 100 and the delivery company server 200 acquire their respective invoices, and the delivery client and the delivery company acquire their respective invoices for the delivery.

### Digital Currency Issuance Process

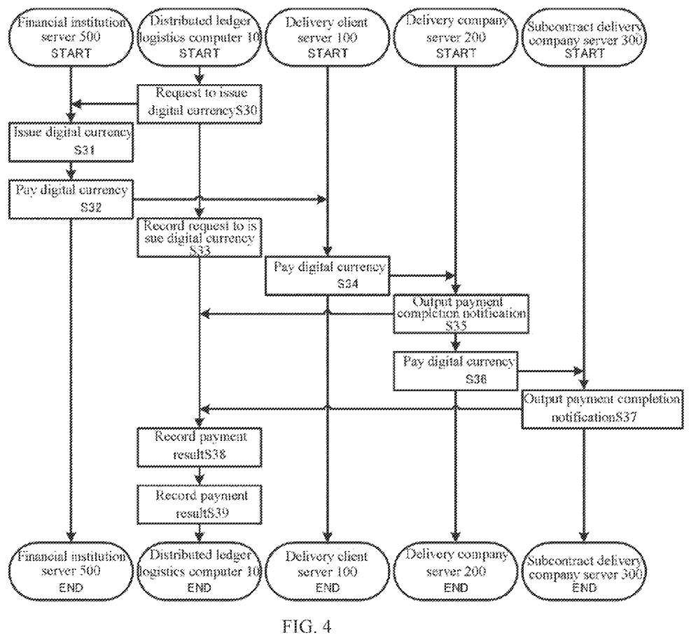

The digital currency issuance process performed by the distributed ledger logistics system 1 is described below with reference to FIG. 4. FIG. 4 is a flowchart of the digital currency issuance process performed by the distributed ledger logistics computer 10, the delivery client server 100, the delivery company server 200, the subcontract delivery company server 300, and the financial institution server 500. The tasks executed by the modules of each of the above-mentioned devices will be explained below together with this process.

When a delivery completion is recorded in the above-mentioned delivery completion writing process, the currency issuance request module 20 outputs a digital currency issuance request to the financial institution server 500 to request the financial institution server 500 to issue a digital currency to be paid from the delivery client to the delivery company (Step S30). In Step S30, the currency issuance request module 20 transmits a digital currency issuance request to the financial institution server 500 to issue a digital currency for the delivery charge specified in the content requested for the completed delivery. The financial institution server 500 receives the digital currency issuance request.

The currency issue module 540 issues a digital currency to be paid from the delivery client to pay to the delivery company based on the acquired digital currency issuance request (Step S31). In Step S31, the currency issue module 540 issues a digital currency for the delivery charge in the digital currency issuance request.

The payment module 520 pays the issued digital currency to the delivery client (Step S32). In Step S32, the payment module 520 transfers the issued digital currency to the delivery client server 100. The delivery client server 100 acquires and records the digital currency. As the result, a bank pays a digital currency to the delivery client (a bank loans the digital currency to the delivery client).

The loaned digital currency may be repaid from not only a party in charge (delivery client) who obtains the loan but also a delivery company, a subcontract delivery company, etc.

The recording module 30 records a request to ask the financial institution server 500 to issue a digital currency in the blockchain 400 (Step S33). In Step S33, the recording module 30 records a request for the issuance of a digital currency in a block for the first channel in the blockchain 400 as a payment result.

The distributed ledger logistics computer 10, the delivery client server 100, the delivery company server 200, and the subcontract delivery company server 300 share and dispersively manage the blockchain 400 in which the payment result is newly recorded.

The payment module 122 pays a digital currency to the delivery company (Step S34). In Step S34, the payment module 122 transfers the digital currency for the delivery charge in the requested content to the delivery company server 200. The delivery company server 200 acquires and records the digital currency. As the result, the delivery client pays the delivery charge to the delivery company as a digital currency.

The payment completion notifying module 224 outputs a payment completion notification that the digital currency was paid to the distributed ledger logistics computer 10 (Step S35). In Step S35, the payment completion notifying module 224 transmits the payment completion notification including information on the payer and the payee, the amount of the paid digital currency to the distributed ledger logistics computer 10. The distributed ledger logistics computer 10 receives the payment completion notification.

The payment module 223 pays a digital currency to the subcontract delivery company (Step S36). In Step S36, the payment module 223 transfers the digital currency for the delivery charge in the content of the subcontract delivery request to the subcontract delivery company server 300. The subcontract delivery company server 300 acquires and records the digital currency. As the result, the delivery company pays the delivery charge to the subcontract delivery company as a digital currency. In the case where a delivery company combines a plurality of delivery requests and make the combined delivery requests to the subcontract delivery company, a digital currency could be insufficient for individual payments. When the digital currency is insufficient for a reason in addition to that described above, the delivery company only has to pay a part of the delivery charge by the digital currency acquired from the delivery client and issue a digital currency for the rest by obtaining a loan from a financial institution to pay all the delivery charges to the subcontract delivery company as a digital currency. When all the payments from the delivery company to the subcontract delivery company are made by using a digital currency, the statuses of the acquisition, the transfer, and the payment of the digital currency are transmitted to the distributed ledger logistics computer 10 in the same way as those described above. In the case where other instruments, for example, cash, bill, check without issuing digital currency, the acquisition, transfer, and payment history is automatically and/or manually transmitted to the distributed ledger logistics computer 10.

The payment completion notifying module 322 outputs a payment completion notification that the digital currency was paid to the distributed ledger logistics computer 10 (Step S37). In Step S37, the payment completion notifying module 332 transmits the payment completion notification including information on the payer and the payee, the amount of the paid digital currency to the distributed ledger logistics computer 10. The distributed ledger logistics computer 10 receives the payment completion notification.

This enables the distributed ledger logistics system 1 to easily reduce the transfer commission to a bank more than ever before by using a digital currency.

The recording module 30 records the payment result of the digital currency to the delivery company in the blockchain 400 based on the payment completion notification generated in the process of the above-mentioned Step S35 (Step S38). In Step S38, the recording module 30 records the payment result of the digital currency to the deliver company in a block for the third channel in the blockchain 400.

The recording module 30 records the payment result of the digital currency to the subcontract delivery company in the blockchain 400 based on the payment completion notification generated in the process of the above-mentioned Step S37 (Step S39). In Step S39, the recording module 30 records the payment result of the digital currency to the deliver company in a block for the second channel in the blockchain 400.

The distributed ledger logistics computer 10, the delivery client server 100, the delivery company server 200, and the subcontract delivery company server 300 share and dispersively manage the blockchain 400 in which the payment result is newly recorded.

As the result, the distributed ledger logistics computer 10 records a request for issuance of a digital currency and the actual issuance in a distributed ledger for currency.

This enables the distributed ledger logistics system 1 to easily guarantee the authenticity of payment result by using the blockchain 400 and easily decrease the clerical work man-hours by using automatic verification.

The distributed ledger logistics system 1 performs the above-mentioned delivery completion writing process and the above-mentioned digital currency issuance process for each delivery.

Although the distributed ledger logistics system 1 issues a digital currency in the above-mentioned digital currency issuance process for each delivery, a digital currency necessary for a delivery request may be previously issued and then held in the distributed ledger logistics computer 10 or the delivery client server 100. In this case, the distributed ledger logistics system 1 pays a digital currency held in the distributed ledger logistics computer 10 or the delivery client server 100 to the delivery company server 200 and the subcontract delivery company server 300 when delivery completion is recorded in the delivery completion writing process.

### Cash Conversion Process

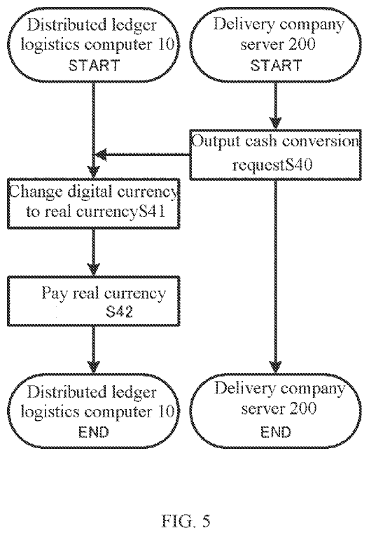

The cash conversion process performed by the distributed ledger logistics system 1 is described below with reference to FIG. 5. FIG. 5 is a flow chart illustrating the cash-conversion process performed by the distributed ledger logistics computer 10 and the delivery company server 200. The tasks executed by the modules of each of the above-mentioned devices will be explained below together with this process. The subcontract delivery company server 300 can perform the same process instead of the delivery company server 200.

The cash conversion request module 225 outputs a cash conversion request of its held digital currency to the distributed ledger logistics computer 10 (Step S40). In Step S40, the cash conversion request module 225 transmits the cash conversion request to the distributed ledger logistics computer 10. The distributed ledger logistics computer 10 receives the cash conversion request.

The cash conversion module 41 changes the digital currency to a real currency based on the cash conversion request (Step S41). In Step S41, the cash conversion module 41 changes the digital currency to a real currency at a predetermined rate.

The predetermined rate can be changed according to the timing of cash conversion (for example, whether or not the timing has come after the days elapsed since the work completion and after a predetermined date), the work difficulty (for example, quality such as no application of a stimulus to the items), the number of the items, etc.

The payment module 21 pays the amount of the real currency to the account, etc., of the delivery company (Step S42). In Step S42, the payment module 21 may pay the amount not only to an account but also in a manner decided on by the delivery company.

Instead of the distributed ledger logistics computer 10, the financial institution server may perform in the above-mentioned process.

The distributed ledger logistics system 1 performs the above-mentioned cash conversion process at a timing that the delivery company or the subcontract delivery company prefers.

### Settlement Process

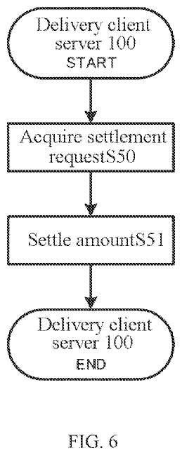

The settlement process performed by the distributed ledger logistics system 1 is described below with reference to FIG. 6. FIG. 6 is a flow chart illustrating the settlement process performed by the delivery client server 100. The tasks executed by the modules are described below with this process.

The settlement request acquisition module 123 acquires a settlement request from the financial institution server 500 to request the settlement of the digital currency requested for the issuance by the distributed ledger logistics computer 10 at predetermined timings such as monthly billing cycles, for example, about once a month (Step S50). In Step S50, the financial institution server 500 outputs the settlement request to the delivery client server 100 to settle the digital currency requested for issuance since the previous settlement by the distributed ledger logistics computer 10 in a real currency. The settlement request acquisition module 123 acquires the settlement request.

The settlement module 124 settles the amount of the real currency based on the settlement request (Step S51). In Step S51, the settlement module 124 settles this amount by paying to a bank. The settlement module 124 may settle this amount in a manner decided on by the bank.

This allows cash to be transferred from a delivery client once a month as usual.

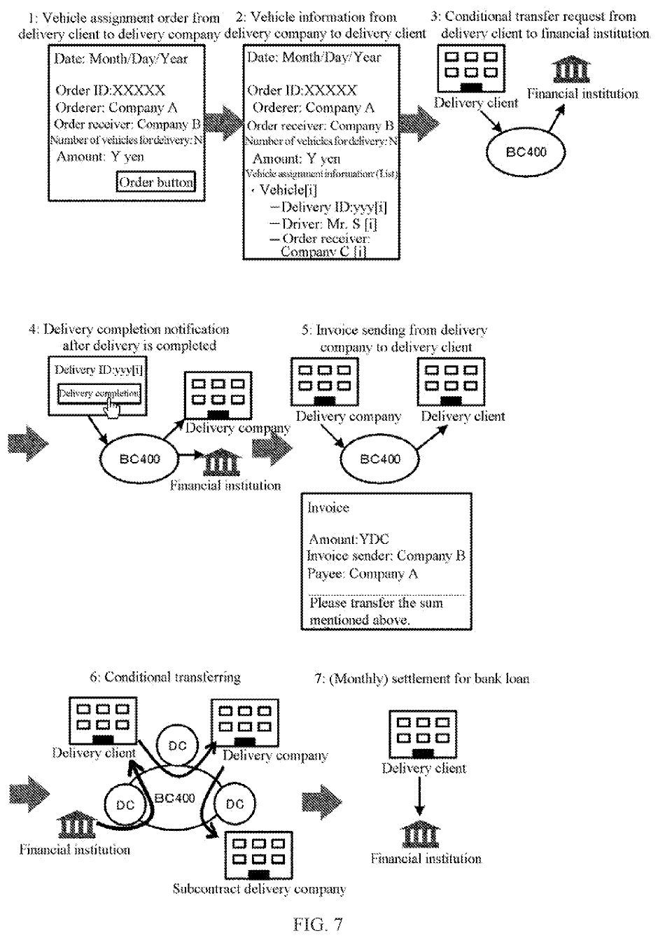

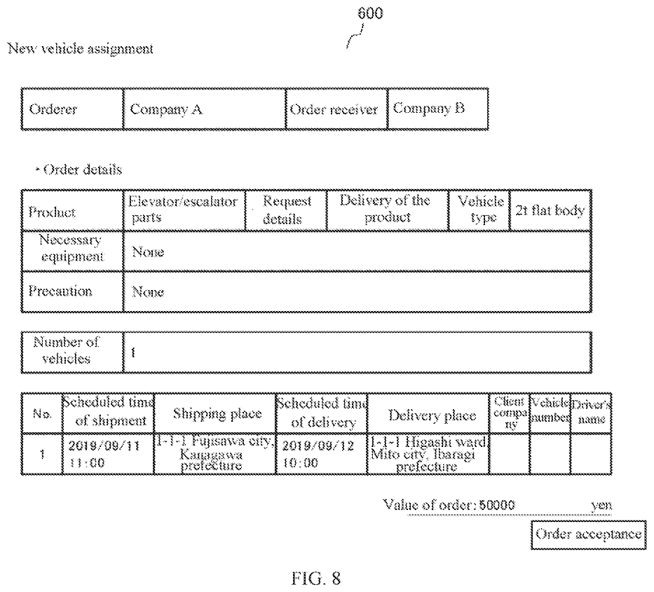

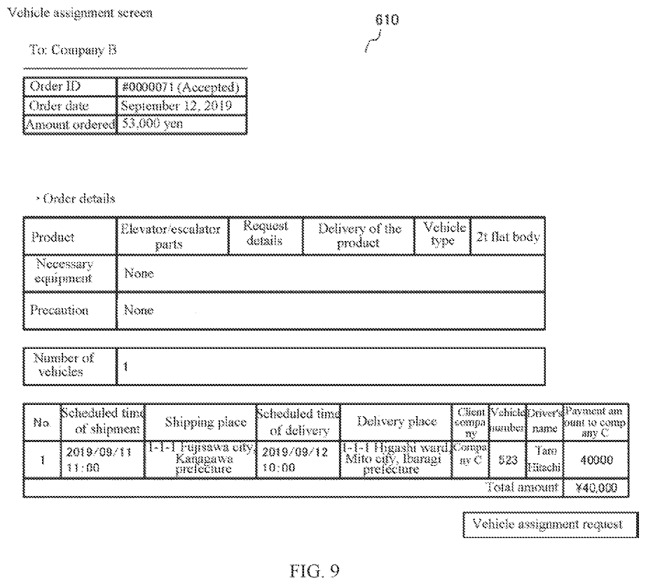

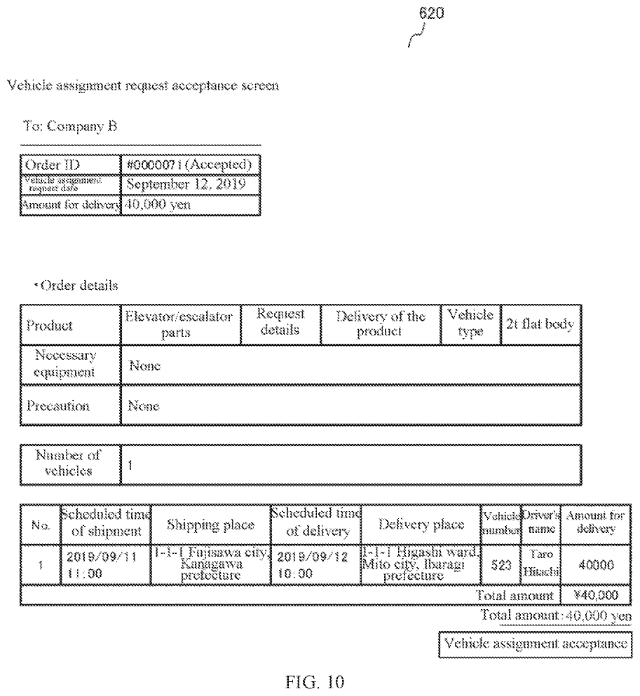

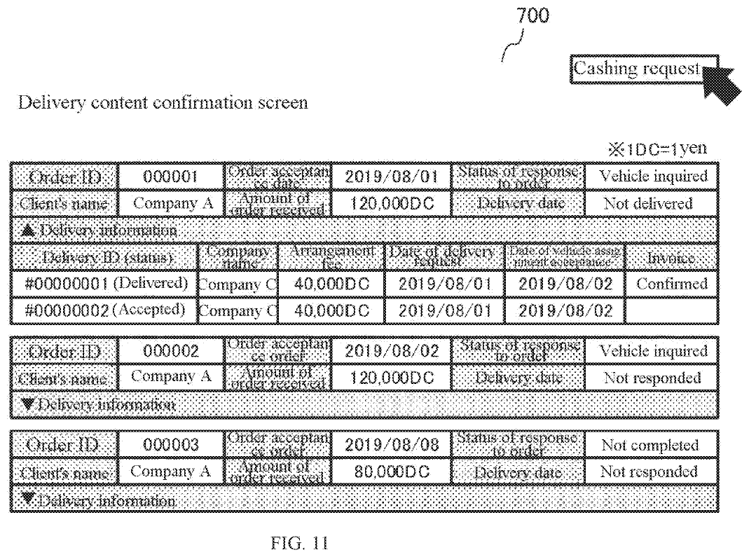

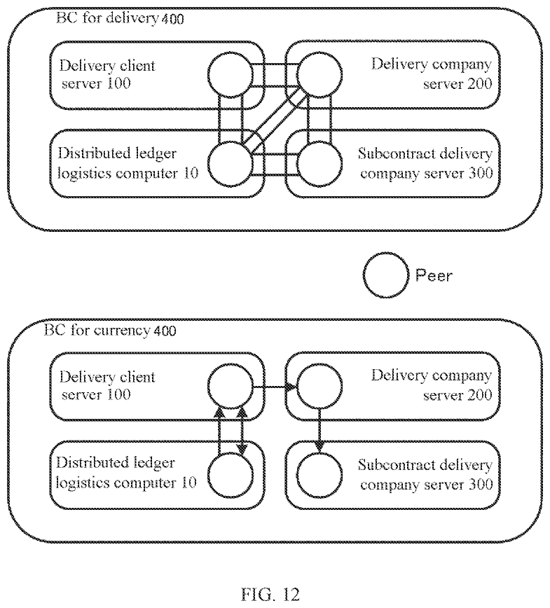

The delivery completion writing process, the digital currency issuance process, the cash conversion process, and the settlement process that are described above are explained below with reference to FIGS. 7-12. FIG. 7 schematically shows the flow of the series of the delivery completion writing process, the digital currency issuance process, the cash conversion process, and the settlement process that are described above. FIG. 8 shows an example delivery request screen. FIG. 9 shows an example subcontract delivery request screen. FIG. 10 shows an example order acceptance screen for a subcontract delivery request. FIG. 11 shows an example order list screen when a digital currency is converted into cash. FIG. 12 shows an example blockchain 400.

### BC (Blockchain) for Delivery 400

The BC for delivery 400 is explained below with reference to FIG. 12. The BC for delivery 400 is shared among the distributed ledger logistics computer 10, the delivery client server 100, the delivery company server 200, and the subcontract delivery company server 300, among the distributed ledger logistics computer 10, the delivery client server 100, and the delivery company server 200, or among the distributed ledger logistics computer 10, the delivery company server 200, and the subcontract delivery company server 300. The order information from a delivery client is shared among the distributed ledger logistics computer 10, the delivery client server 100, and the delivery company server 200. The order information from a delivery company is shared among the distributed ledger logistics computer 10, and the delivery company server 200, and the subcontract delivery company server 300. The delivery completion is shared among the distributed ledger logistics computer 10, the delivery client server 100, the delivery company server 200, and the subcontract delivery company server 300.

### BC for Currency 400

The BC for currency 400 is explained below with reference to FIG. 12. The BC for currency 400 notifies that the distributed ledger logistics computer 10 has received a request for PAYG from the delivery client server 100. The distributed ledger logistics computer 10 requests the financial institution server 500 to issue a DC (digital currency) according to the DC issuance request from the delivery client. The financial institution server 500 issues and pays the DC to the delivery client. The delivery client pays the DC to the delivery company. The delivery company pays the DC to the subcontract delivery company. The BC for currency 400 records all the payment results, which is shared among the distributed ledger logistics computer 10, the delivery client server 100, the delivery company server 200, and the subcontract delivery company server 300.

Not only an original private coin such as a DC but also an original coin agreed in a preliminarily formed consortium or an existing currency as described above may be used as the digital currency.

1: Vehicle Assignment Order from Delivery Client to Delivery Company

The delivery client server 100 receives an input for a vehicle assignment order to a delivery company as a delivery request and outputs the accepted vehicle assignment order to the delivery company server 200. The delivery client server 100 receives an input for necessary information to the new vehicle assignment order screen 600 shown in FIG. 8 and transmits the received content to the delivery company server 200 as a delivery request. The necessary information includes the orderer, the order receiver, the name of the product, the request details, the necessary equipment, the precaution, the type and the number of vehicles necessary for delivery, the scheduled time and the place of shipment, the scheduled time of delivery, the delivery place, and the value of an order.

The delivery company server 200 receives an input for a vehicle assignment order to a subcontract delivery company as a subcontract delivery request and outputs the accepted vehicle assignment request to the subcontract delivery company server 300. The delivery company server 200 receives an input for necessary information to the vehicle assignment order screen 610 shown in FIG. 9 and transmits the received content to the subcontract delivery company server 300 as a vehicle assignment request. The necessary information includes the name of the product, the request details, the necessary equipment, the precaution, the type and the number of the scheduled time and the place of shipment, the scheduled time of delivery, the delivery place, the value of an order, the name of the delivery company who made the request, the vehicle number, the driver's name, and the payment amount.

The subcontract delivery company server 300 outputs the vehicle information that the vehicle assignment request has been accepted to the delivery company server 200 as a subcontract order acceptance notification. The subcontract delivery company server 300 receives an input for vehicle assignment request acceptance to the vehicle assignment acceptance screen 620 shown in FIG. 10 and transmits the received content to the delivery company server 200 as vehicle information.

2: Vehicle Information from Delivery Company to Delivery Client

The delivery company server 200 outputs the received vehicle information to the delivery client server 100.

3: Conditional Transfer Request from Delivery Client to Bank

The distributed ledger logistics computer 10 records the vehicle information for the delivery request from a delivery client in the BC for delivery 400. The distributed ledger logistics computer 10 records the vehicle information in a block for the appropriate channel in the BC for delivery 400.

The delivery client server 100 responds the conditional transfer request to pay the charge in the delivery request from the financial institution server 500 to a delivery company. The delivery client server 100 requests the financial institution server 500 to transfer the digital currency for the charge when the delivery is completed. At this time, the delivery client server 100 may make a conditional transfer request to the financial institution server 500 directly or through the distributed ledger logistics computer 10.

4: Delivery Completion Notification after Delivery is Completed

The subcontract delivery company server 300 outputs a delivery completion notification to the distributed ledger logistics computer 10. The distributed ledger logistics computer 10 records the delivery completion notification in a block for the appropriate channel in the BC for delivery 400.

The distributed ledger logistics computer 10 notifies a delivery company and a bank about delivery completion.

5: Invoice Sending from Delivery Company to Delivery Client

The delivery company server 200 outputs an invoice to the delivery client server 100.

### 6: Conditional Transferring

The financial institution server 500 issues the DC to the delivery client according to the conditional transfer request. The delivery client pays the charge to the delivery company by using the DC. The delivery company pays the charge to the subcontract delivery company by using the paid DC.

When a delivery company cashes the digital currency, the delivery company server 200 performs the necessary process by receiving an input of a cashing request to the delivery content confirmation screen 700 shown in FIG. 11. The same applies to when a subcontract delivery company cashes the digital currency. The distributed ledger logistics computer 10 records the payment result in a block for the appropriate channel in the BC for currency 400.

### 7: (Monthly) Settlement for Bank Loan

The delivery client server 100 settles the issued digital currency for the financial institution server 500.

To achieve the means and the functions that are described above, a computer (including a CPU, an information processor, and various terminals) reads and executes a predetermined program. For example, the program may be provided through Software as a Service (SaaS), specifically, from a computer through a network or may be provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to those described in the embodiments of the present invention.

### DESCRIPTION OF REFERENCE NUMERALS

1 Distributed ledger logistics system, 10 Distributed ledger logistics computer, 100 Delivery client serves, 200 Delivery company server, 300 Subcontract delivery company server, 400 Blockchain, 500 Financial institution server

1. A distributed ledger logistics computer comprising:
a distributed delivery ledger writing unit that records the content of a request from a delivery client to a delivery company when the delivery company receives and accepts a delivery request from the delivery client and records delivery completion in a distributed ledger for delivery when the requested order has been delivered; and
a digital currency issuance request unit that requests a financial institution server to issue a digital currency to be paid from the delivery client to the delivery company when the delivery completion is recorded.

2. The distributed ledger logistics computer according to claim 1, wherein a request made by the digital currency issuance request unit to ask the financial institution server to issue a digital currency is recorded in a distributed ledger for currency.

3. A distributed ledger logistics system, in which the distributed ledger for delivery of the distributed ledger logistics computer according to claim 1 is dispersively managed among at least the distributed ledger logistics computer, the delivery client server managed by the delivery client, and the delivery company server managed by the delivery company.

4. The distributed ledger logistics system according to claim 3, comprising a digital currency payment unit that, in the case where the delivery company server requests a subcontract company for the content of the request, has the delivery company pay a digital currency to the subcontract delivery company when the delivery completion is recorded.

5. A method for distributed ledger logistics, the method performed by a computer, comprising the steps of:
recording the content of a request from a delivery client to a delivery company when the delivery company receives and accepts a delivery request from the delivery client and recording delivery completion in a distributed ledger for delivery when the requested order has been delivered; and
requesting a financial institution server to issue a digital currency to be paid from the delivery client to the delivery company when the delivery completion is recorded.

6. (canceled)
